(19) United States
(12) Patent Application Publication
(10) Pub. No.: US 2021/0024753 A1
(43) Pub. Date: Jan. 28, 2021

(54) FORMULATION FOR BITUMEN EMULSION

(71) Applicant: Arkema France, Colombes (FR)

(72) Inventors: Eric Jorda, Lyon (FR); Rabi Inoubli, Villeurbanne (FR); Françoise Achard, Feyzin (FR)

(73) Assignee: Arkema France, Colombes (FR)

(21) Appl. No.: 16/980,661

(22) PCT Filed: Mar. 20, 2019
(86) PCT No.: PCT/FR2019/050636

§ 371 Date: Sep. 14, 2020

(30) Foreign Application Priority Data
Mar. 23, 2018 (FR) 1852572

(51) Int. Cl. C08L 95/00; C08K 5/42; C08K 5/17

(52) U.S. Cl. CPC C08L 95/005; C08K 5/17; C08K 5/42

(57) ABSTRACT

A formulation comprising at least one lignosulfonate, at least one nitrogenous surfactant, and at least one alkoxylated cationic compatibiliser is described in addition to bitumen emulsions produced from said formulation.

The present invention relates to formulations, and in particular formulations based on surfactants, which are notably useful for the preparation of bitumen emulsions, and more specifically for the preparation of bitumen emulsions for gravel emulsions. The present invention also relates to the bitumen emulsions prepared with said formulations, and also to the uses thereof for the preparation of gravel emulsions and other types of emulsions.

The surfactants market for bitumen emulsions is currently in continuous expansion, most particularly for the gravel emulsion market. These additives are of most particular importance for bitumen emulsions of this type, insofar as they play an important role not only in the stability of bitumen emulsions but also in the robustness of the bituminous surfacing mixes prepared with said emulsions.

One class of additives, notably based on lignosulfonates, has been the subject of extensive research for many years. Thus, the first use of lignosulfonates as stabilizers for bitumen emulsions was published in 1950 by D. Jesseph (cf. U.S. Pat. No. 2,494,708), which adds an ammonium lignosulfonate to an emulsion after manufacture. However, this technology does not make it possible to achieve the mechanical properties required for surfacing mixes obtained from bitumen emulsions.

In patent BE 579421, it is taught that it is necessary to perform chemical treatments on lignin, for example lignosulfonates, in order to produce condensates that are useful in various applications, for instance the emulsification of bitumens.

Still in the field of bitumens, patent U.S. Pat. No. 3,126,350 describes the manufacture of cationic bitumen emulsions over-stabilized with a lignin, which is also chemically modified. The chemical modifications impose additional operations and constraints, which may be a drawback as regards industrial preparation and the cost price of the resulting bitumen emulsions.

As regards patent U.S. Pat. No. 3,859,227, it discloses slow-setting cationic bitumen formulations comprising at least one alkoxylated alkylphenol. However, such alkoxylated alkylphenols are strictly controlled, these products nowadays being considered as potentially presenting risks to human health.

U.S. Pat. No. 6,840,991 shows that lignosulfonates are not the best suited for the preparation of stable bitumen emulsions; specifically, the lignosulfonate-based formulations presented have only relatively mediocre aggregate coating properties.

A need consequently remains for bitumen emulsion additives, which do not have the drawbacks encountered with the additives of the prior art. The object of the present invention is thus to provide surfactants, notably cationic surfactants, for preparing bitumen emulsions that are stable on storage giving an easy and efficient coating, while at the same time not being sensitive to ravelling when the surfacing mix is worked on a work site. Yet other objects will become apparent in the description of the present invention that follows.

The Applicant has now discovered that it is possible to achieve, totally or at least partly, the objectives listed above, by means of the present invention which enables, inter alia, the preparation of bitumen emulsions which lead to very easy coating of any type of aggregate, the surfacing mixes obtained being very sparingly sensitive to ravelling when worked on a work site, and having good moisture resistance.

Thus, and according to a first aspect, the present invention relates to a formulation comprising at least one lignosulfonate, at least one nitrogenous surfactant and at least one alkoxylated cationic compatibilizer.

More precisely, the present invention relates to a formulation comprising:

a) at least one nitrogenous cationic surfactant bearing at least one optionally quaternized fatty chain, and including from 0 to 5, limits inclusive, preferably 0 to 3, limits inclusive, alkoxylated units;
b) at least one alkoxylated cationic compatibilizer, including from 5 to 25, limits exclusive, and preferably from 10 to 23, limits exclusive, alkoxylated units; and
c) at least one lignosulfonate.

For the purposes of the present invention, the term “nitrogenous cationic surfactant” means any liquid or solid surfactant obtained from amine chemistry, which is generally sparingly water-soluble, and which dissolves readily by ionization in an acidified aqueous phase. This cationic ionization (positive charge) in acidic medium of the amine function(s) activates the hydrophilic part of the surfactant. This cationic surfactant definition is known to and acknowledged by a person skilled in the art who is a specialist in bitumen additives, as described, for example, in the publication “Matériaux bitumineux couleś à froid [Cold-laid bituminous materials], Guide technique [Technical guide]© 2017 Cerema, ISBN: 978-2-37180-202-5, ISSN: 2276-0164.

According to a preferred aspect, said at least one nitrogenous surfactant a) is chosen from amine surfactants of fatty amine or alkylamidoamine or alkylimidazoline type, and mixtures thereof. Surfactant a) may optionally include up to 5 alkoxylated units and comprises at least one linear or branched, saturated or unsaturated hydrocarbon-based chain, including from 8 to 30 carbon atoms, limits inclusive.

More specifically, said at least one nitrogenous surfactant a) is chosen from: i) an optionally alkoxylated fatty monoamine of formula (I) below:

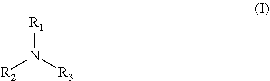

in which
R₁ represents a saturated or unsaturated, linear or branched hydrocarbon-based chain, including from 8 to 30 carbon atoms, preferably from 8 to 24 carbon atoms, preferentially 12 to 24 carbon atoms and even more preferentially 12 to 18 carbon atoms, limits inclusive,
R₂ and R₃, which may be identical or different, are chosen, independently of each other, from a hydrogen atom, a linear or branched, saturated or unsaturated alkyl radical, including from 1 to 4 carbon atoms, and an alkoxylated unit (CH₂CHR₄O)ₕH, in which R₄ represents a hydrogen atom or a methyl or ethyl radical, h being a number ranging from 1 to 5, preferentially from 1 to 3 and even more preferentially from 1 to 2, limits inclusive, it being understood that if h is strictly greater than 1, then the groups R₄ may be identical or different;
   ii) an optionally alkoxylated fatty polyamine of formula (II) below:

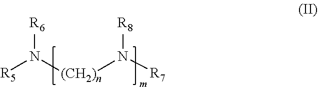

in which
R₅ represents a saturated or unsaturated, linear or branched hydrocarbon-based chain, including from 8 to 30 carbon atoms, preferably from 8 to 24 carbon atoms, preferentially 12 to 24 carbon atoms and even more preferentially 12 to 18 carbon atoms, limits inclusive,
R₆, R₇ and R₈, which may be identical or different, are chosen, independently of each other, from a hydrogen atom, a linear or branched, saturated or unsaturated alkyl radical, including 1 to 4 carbon atoms, and an alkoxylated unit —(CH₂CHR₉O)ᵢH, in which R₉ represents a hydrogen atom or a methyl or ethyl radical, i being a number ranging from 1 to 5, preferentially from 1 to 3 and even more preferentially from 1 to 2, limits inclusive, it being understood that if h is strictly greater than 1, then the groups R₉ may be identical or different;
m denotes a number chosen from 1, 2, 3, 4, 5 and 6, preferentially from 1, 2, 3 and 4 and more preferentially from 1 and 2, it being understood that when m is strictly greater than 1, then the groups R₈ may be identical or different,
n denotes a number chosen from 1, 2, 3, 4, 5 and 6, preferentially from 2, 3 and 4 and more preferentially from 2 and 3; and
   iii) an optionally alkoxylated fatty amidoamine, of formula (IIIa) below or the optionally alkoxylated cyclized equivalent thereof, of formula (IIIb) below:
   in which

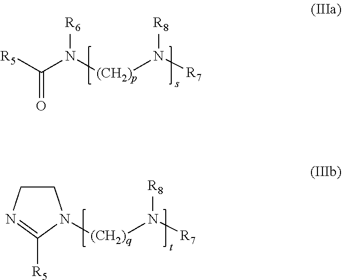

the groups R₅, R₆, R₇ and R₈ are as defined previously,
p and q are chosen from 1, 2, 3, 4, 5 and 6, preferentially from 1, 2, 3 and 4 and more preferentially p and q each represent 2,
s denotes an integer between 1 and 10, limits inclusive, preferentially between 1 and 4, limits inclusive, and even more preferentially 1, 2 or 3,
t denotes an integer between 0 and 9, preferentially between 0 and 3, limits inclusive, and even more preferentially 0, 1 or 2,
it being understood that when s and t are strictly greater than 1, then the groups R₈ may be identical or different.

Advantageously, said at least one nitrogenous surfactant a) is chosen from fatty amines and polyamines based on coconut, tallow or palm and sparingly ethoxylated derivatives thereof (0 to 5 OE), mixtures of fatty alkylamidopolyamine and of alkylimidazopolyamines obtained by reaction of fatty acids or of plant or animal oils (typically triglycerides) such as coconut, tallow, palm, pine (or tall oil) fatty acids, octanoic, nonanoic, decanoic, undecanoic, dodecanoic, lauric, myristic, cetylic, stearic, oleic, arachidic or behenic acid with polyethylene polyamines such as diethylenetriamine (DETA), triethylenetetramine (TETA), tetraethylenepentamine (TEPA), aminoethylpiperazine (AEP) and pentaethylenehexamine (PEHA).

Other polyaminoalkylamines such as dimethylaminopropylamine (DMAPA) or dimethylaminopropylaminopropylamine (DMAPAPA) may also be used for the condensation reaction with said fatty acids.

Even more advantageously, said at least one nitrogenous surfactant a) is chosen from the commercial surfactants obtained from the chemistry of fatty polyamines and alkoxylated fatty polyamines, for instance the products Dinoram® S, Dinoram® O, Dinoram® SLB and Polyram® S sold by CECA S.A., and also products derived from the condensation of fatty monoacids or polyacids with polyaminoalkylamines or polyethanolamines, for instance the products Emulsamine® L60, Emulsamine® L70, Emulsamine® L85, Cecabase® 3860 and Emulsamine® LZ sold by CECA S.A.

More specifically, said at least one alkoxylated cationic compatibilizer b) is a compound chosen from fatty-chain amines, fatty-chain alkylamidoamines, fatty-chain alkylimidazolines, quaternized derivatives of said amines, alkylamidoamines and alkylimidazolines, and mixtures thereof. Said at least one compatibilizer b) includes from 5 to 25, limits exclusive, and preferably from 10 to 23, limits exclusive, alkoxylated units and comprises at least one linear or branched, saturated or unsaturated hydrocarbon-based chain, including from 8 to 30 carbon atoms, limits inclusive.

According to yet another preferred embodiment, said at least one alkoxylated cationic compatibilizer b) is chosen from:

i) an alkoxylated fatty monoamine of formula (I′) below:

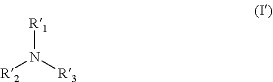

in which
R′₁ represents a saturated or unsaturated, linear or branched hydrocarbon-based chain, including from 8 to 30 carbon atoms, preferably from 8 to 24 carbon atoms, preferentially 12 to 24 carbon atoms and even more preferentially 12 to 18 carbon atoms, limits inclusive,
R′₂ and R′₃, which may be identical or different, represent, independently of each other, an alkoxylated unit (CH₂CHR′₄O)ⱼH, in which R′₄ represents a hydrogen atom or a methyl or ethyl radical, j representing the total number of alkoxylated units per mole of compound of formula (I′) and being a number ranging from 5 to 25, preferentially from 8 to 23 and even more preferentially from 9 to 21, limits exclusive, it being understood that the groups R′₄ may be identical or different;
   ii) an alkoxylated fatty polyamine of formula (II′) below:

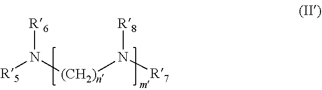

in which
R′₅ represents a saturated or unsaturated, linear or branched hydrocarbon-based chain, including from 8 to 30 carbon atoms, preferably from 8 to 24 carbon atoms, preferentially 12 to 24 carbon atoms and even more preferentially 12 to 18 carbon atoms, limits inclusive,
R′₆, R′₇ and R′₈, which may be identical or different, represent, independently of each other, an alkoxylated unit (CH₂CHR′₉O)ⱼH, in which R′₉ represents a hydrogen atom or a methyl or ethyl radical, j representing the total number of alkoxylated units per mole of compound of formula (II′) and being a number ranging from 5 to 25, preferentially from 8 to 23 and even more preferentially from 9 to 21, limits exclusive, it being understood that the groups R′9 may be identical or different;
m′ denotes a number chosen from 1, 2, 3, 4, 5 and 6, preferentially from 1, 2, 3 and 4 and more preferentially from 1 and 2, it being understood that when m′ is strictly greater than 1, then the groups R′8 may be identical or different,
n′ denotes a number chosen from 1, 2, 3, 4, 5 and 6, preferentially from 2, 3 and 4 and more preferentially from 2 and 3; and
   iii) an alkoxylated fatty amidoamine, of formula (III′a) below or the cyclized equivalent thereof of formula (III′b) below:

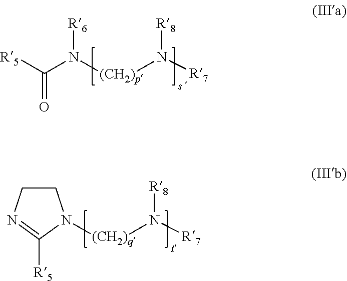

in which
the groups R′₅, R′₆, R′₇ and R′₈ are as defined previously,
p′ and q′ are chosen from 1, 2, 3, 4, 5 and 6, preferentially from 1, 2, 3 and 4 and more preferentially p′ and q′ each represent 2,
s′ denotes an integer between 1 and 10, limits inclusive, preferentially between 1 and 4, limits inclusive, and even more preferentially 1, 2 or 3,
t′ denotes an integer between 0 and 9, preferentially between 0 and 3, limits inclusive, and even more preferentially 0, 1 or 2,
it being understood that when s′ and t′ are strictly greater than 1, then the groups R′₈ may be identical or different.

Advantageously, said at least one alkoxylated cationic compatibilizer b) is chosen from:
fatty amines and polyamines based on coconut, tallow or palm, and including in total from 5 to 25 (limits exclusive) ethoxylated units per mole,
methyl chloride-quaternized derivatives of fatty amines and polyamines based on coconut, tallow or palm, and including in total from 5 to 25 (limits exclusive) ethoxylated units per mole,
ethoxylated derivatives (total ethoxylated units between 5 and 25 per mole, limits exclusive) of mixtures of fatty alkylamidopolyamine and of fatty alkylimidazopolyamines obtained by reaction of fatty acids or of plant or animal oils (typically triglycerides) such as coconut, tallow, palm, pine (or tall oil) fatty acids, octanoic, nonanoic, decanoic, undecanoic, dodecanoic, lauric, myristic, cetylic, stearic, oleic, arachidic or behenic acid with polyethylene polyamines such as diethylenetriamine (DETA), triethylenetetramine (TETA), tetraethylenepentamine (TEPA), aminoethylpiperazine (AEP), pentaethylenehexamine (PEHA), dimethylaminopropylamine (DMAPA) and dimethylaminopropylaminopropylamine (DMAPAPA).

Even more advantageously, said at least one alkoxylated cationic compatibilizer b) is chosen from commercial surfactants obtained from the chemistry of alkoxylated fatty polyamines, for instance the products Dinoramox® S12, Noramox® S11, Noramox® C11 sold by CECA S.A. or Ethoduomeen® T25, Ethomeen® 18/25, Ethomeen® C/25, Ethomeen® T/25 and Ethomeen® T/30 sold by AkzoNobel, and also ethoxylated quaternized derivatives, such as Inipol® CX15 sold by CECA S.A or Ethoquad® 18/25, Ethoquad® C/25 and Ethoquad® T/25 sold by AkzoNobel.

In the present invention, the term “alkoxylated” typically refers to units known under the names “oxy-ethylene” (OE), “oxy-propylene” (OP) and oxy-butylene” (OB), and more specifically to OE and OP units, preferably only OE units. It should be understood that when several alkoxylated units are present in one of the components a) and/or b) of the formulation of the present invention, said several alkoxylated units may be identical or different.

According to one embodiment of the invention, component a) and/or component b), preferably component b), of the formulation according to the invention may be present in quaternized form. The term “quaternized form” means that one or more nitrogen atoms present have been subjected to an alkylation reaction.

This alkylation reaction is preferably performed with an alkylating agent of formula R_{A}X, in which R_{A} is an alkyl radical, preferably a C₁-C₄ alkyl radical, and X is a leaving group well known to those skilled in the art, and preferably X is chosen from halogens, sulfates, carbonates, and the like.

The formulation according to the invention comprises at least one lignosulfonate (component c)), which may be of any type that is well known to those skilled in the art. The preferred lignosulfonates are chosen from sodium, calcium, magnesium or ammonium lignosulfonates and preferably from sodium lignosulfonates.

The lignosulfonates c) that are most particularly preferred for the formulations of the present invention generally have a low molar mass, and preferably a weight-average molar mass (M_{w}) of between 1 kg·mol⁻¹ and 35 kg·mol⁻¹, preferably between 1 kg·mol⁻¹ and 30 kg·mol⁻¹, more preferably between 1 kg·mol⁻¹ and 20 kg·mol⁻¹, typically between 5 kg·mol⁻¹ and 20 kg·mol⁻¹, limits inclusive.

In the formulation of the present invention, the component b)/component c) weight ratio is between 0.1 and 4, preferably between 0.5 and 2, limits inclusive, and the component a)/component b) weight ratio is between 0.1 and 2, preferably between 0.25 and 1, limits inclusive.

The formulation according to the invention may be supplemented with water so as to control its viscosity. The amount of water that may be present in the formulation may vary within very wide proportions and may generally be between 0 and 99.99% by weight of water relative to the total weight of the formulation, limits exclusive, preferably between 1% and 99% by weight of water relative to the total weight of the formulation, limits inclusive.

The formulation according to the invention may advantageously be used to form emulsions, and in particular bitumen emulsions. To this end, the formulation according to the invention may be supplemented with water and with acid so as to form a soap. The amount of water that may be present in the soap may vary within very wide proportions and may generally be between 0 and 99.99% by weight of water relative to the total weight of the soap, limits exclusive, preferably between 1% and 99% by weight of water relative to the total weight of the soap, limits inclusive.

According to a preferred embodiment, the soap as defined above is in the form of an “acidic” soap. For the purposes of the present invention, the term “acidic” means that the pH of the soap is less than 7, preferably less than 6; more preferably, it is between 0 and 7, preferably between 1 and 6, preferably between 1 and 4, for example 2. The pH value may be adjusted by adding a strong or weak organic or mineral acid.

Preferably, the pH value is adjusted, for example, by adding at least one acid chosen, for example, and in a nonlimiting manner, from phosphoric acids, hydrochloric acid, acetic acid, and mixtures of two or more thereof in all proportions.

The formulation according to the present invention, and the soaps prepared from said formulation, are generally in liquid form at ambient temperature, of homogeneous appearance, and free of precipitate.

The formulation according to the present invention, and the soaps prepared from said formulation, may optionally comprise one or more additives commonly used in the field, among which mention may be made in a nonlimiting manner of rheological agents, colorants, stabilizers, surfactants, and also any other additive that is well known to those skilled in the art. According to a preferred aspect, the additives that may be present do not include a (hetero)aromatic nucleus; entirely preferably, the formulation of the invention, and the soaps containing same, cannot contain any alkoxylated alkylphenol, for instance alkoxylated nonylphenol.

In a second aspect, the present invention relates to the use of the formulation described above as surfactant for the preparation of a bitumen emulsion.

It has thus been discovered, and this represents another aspect of the present invention, that bitumen emulsions prepared using the formulations according to the invention as defined above are stable and have good application properties as surfacing mixes.

According to one embodiment of the invention, the formulation is used at low dosage, typically between 0.1% and 5%, preferably between 0.1% and 3%, more preferably between 0.5% and 2.0%, by weight of formulation, limits inclusive, relative to the total weight of the bitumen emulsion.

The bitumen emulsions thus prepared comprise from 30% to 70% by weight of bitumen and preferably from 40% to 70% by weight of bitumen relative to the total weight of the emulsion, the remainder to 100% by weight being provided by water.

Another advantage associated with the use of the formulation according to the present invention lies in the fact that it is not obligatory or necessary also to add an additive, for example of alkoxylated alkylphenol type, in order to obtain stable bitumen emulsions which have good application properties as surfacing mixes.

The present invention also relates to a process for preparing a bitumen emulsion using at least one formulation as described previously, said process comprising at least one step of mixing, preferably at high shear, at least one bitumen, at least one formulation as defined previously and water. The order of addition (bitumen, formulation, water) will be adapted as a function of the nature of the bitumen, of the formulation and also of the knowledge of a person skilled in the art. The process also comprises an optional step of acidification of the medium so as to obtain a pH value as indicated previously.

The process is generally performed at a temperature that is sufficient to ensure good homogenization, as a function of the type of bitumen used. As a general rule, the emulsion is prepared at a temperature between ambient temperature and 160° C., preferably between 40° C. and 160° C., more preferably between 60° C. and 150° C. and more generally between 60° C. and 140° C., for example between 70° C. and 140° C. The bitumen emulsion preparation temperature may typically be adapted as a function of the penetrability of the bitumen used, as is well known to those skilled in the art.

According to a preferred aspect of the process for preparing the emulsion according to the present invention, a soap is prepared, at ambient temperature, or with gentle heating (40° C.−50° C. maximum), by dispersing at least one formulation as defined previously in water, and this soap is then acidified (generally to a pH of between 1.5 and 5 and preferably between 2 and 3.5) by adding at least one acid. The “acidic” soap thus obtained is then mixed at high shear with at least one bitumen at the temperatures indicated above.

The mixing at high shear may be performed using any apparatus known to those skilled in the art. By way of nonlimiting example, mention may be made of devices of colloid mill type, of which that of the Atomix® brand name is a representative.

Thus, and according to a preferred embodiment, the present invention relates to a process for preparing a bitumen emulsion as defined above, said process comprising:
at least one step of mixing, preferably at high shear, at least one bitumen, at least one formulation as claimed in any one of claims 1 to 10 and water,
an optional step of acidification of the medium so as to obtain a pH value of less than 7, preferably less than 6, more preferably between 0 and 7, preferably between 1 and 6, preferably between 1 and 4, for example 2,
   said process being performed at a temperature between ambient temperature and 160° C., preferably between 40° C. and 160° C., more preferably between 60° C. and 150° C., more generally between 60° C. and 140° C., for example between 70° C. and 140° C.

The bitumen emulsion may optionally comprise one or more additives commonly used in the field, among which mention may be made in a nonlimiting manner of viscosity enhancers, natural or synthetic latices, thickeners, fluxing agents, plasticizers, and also any other additive for adjusting the properties of the emulsion, such as the processing additives mentioned in patent EP 1057873 B1.

The bitumens used in the invention may be of any type known to a person skilled in the art, and may be obtained from various sources, for example those of natural origin, those contained in natural bitumen deposits, natural asphalt deposits or bituminous sands. In the context of the present invention, the bitumens may also be bitumens obtained from refining crude oil (atmospheric and/or vacuum distillation of oil), these bitumens possibly being blown, visbroken and/or deasphalted bitumens.

The bitumens may be hard-grade or soft-grade bitumens. The various bitumens obtained by means of refining processes may be combined together to obtain the best technical compromise.

The bitumens used may also be bitumens fluxed by addition of volatile solvents, of fluxing agents of petroleum origin, of carbochemical fluxing agents and/or of fluxing agents of plant origin.

Polymer-modified bitumens may also be used. Examples of polymers that may be mentioned, in a nonlimiting manner, include thermoplastic elastomers, for instance statistical or block copolymers of styrene and of butadiene, in linear or starburst form (SBR, SBS) or of styrene and isoprene (SIS), which are optionally crosslinked, copolymers of ethylene and of vinyl acetate, olefinic homopolymers and copolymers of ethylene (or propylene or butylene), polyisobutylenes, polybutadienes, polyisoprenes, poly(vinyl chloride)s, crumb rubbers or any polymer used for bitumen modification, and also mixtures thereof. An amount of polymer of from 2% to 10% by weight relative to the weight of bitumen is generally used.

Synthetic bitumens, also known as clear, pigmentable or colorable bitumens, may also be used. These bitumens contain little or no asphaltenes and can consequently be colored. These synthetic bitumens are based on petroleum resin and/or on indene-coumarone resin and on lubricating oil as described, for example, in patent EP 179510.

Advantageously, the bitumen is a bitumen with a penetrability, measured according to the standard EN1426, of between 10 and 300, preferably between 20 and 220, more preferentially between 70 and 220.

The invention also relates to surfacing mixes prepared with the abovementioned bitumen emulsions and aggregates. More particularly, the invention relates to surfacing mixes comprising at least one bitumen emulsion as described previously in the present description and aggregates.

The aggregates that may be used for the preparation of the surfacing mixes according to the present invention may be of any type known to those skilled in the art. Among the aggregates that may be used for the surfacing mixes of the present invention, mention may notably be made, in a nonlimiting manner, of aggregates of mineralogical nature, for example of eruptive nature, such as granites, porphyry stones and basalts, of metamorphic nature, such as schists and gneisses, and of sedimentary nature of siliceous type, such as silexes and quartzites, and of carbonated type, such as limestones and dolomites, but also surfacing mix (or recycled) aggregates, clinkers, crushed concretes, and the like, and also mixtures of such aggregates.

The surfacing mixes of the present invention may be prepared from at least one bitumen emulsion and aggregates according to any method known to those skilled in the art, for example by mixing the emulsion with the aggregates.

The emulsions of the present invention are thus particularly suitable for the preparation of surfacing mixes, for example semi-warm surfacing mixes, i.e. surfacing mixes in which the temperature of the aggregates during the phase of mixing with the bitumen emulsion is between ambient temperature and 100° C., for example also cold-laid surfacing mixes, among which mention may be made, in a nonlimiting manner, of gravel emulsions (structuring or reprofiling gravel emulsions), cold-laid bituminous concretes, dense, semi-dense or open storable surfacing mixes, and the like.

The emulsions of the present invention are also particularly suitable for making tack coats, for stabilizing grounds and for impregnation works, for instance “prime coat”, cold-in-place recycling (or CIPR), the preparation of coatings, optionally in combination with one or more other additives and/or fillers, for instance clays, limestone powder or cement, in order to prepare sealing coatings and the like.

The invention will be better understood in light of the following examples, which are given purely by way of illustration and in no way limit the scope of the invention.

### EXAMPLES

In order to test them, various formulations are prepared from lignosulfonates of diverse origin and of diverse properties.

The lignosulfonates used are presented in Table 1 below:

TABLE 1

| Supplier | Lignosulfonate | M_{w} (kg · mol⁻¹) |
|---|---|---|
| Borregaard | Vanisperse CB | 12.920 |
| Tembec | Arbo ™ BL | 15.735 |
| Tembec | GSA ® | 16.210 |

The weight-average molar masses (M_{w}) are determined by size exclusion chromatography, using a three-column system:

first column: Waters Ultrahydrogel Linear, 300×7.8 mm,
second and third columns: Waters Ultrahydrogel 120 Å, 300×7.8 mm.

For this determination, the injection flow rate is set at 0.8 mL·min⁻¹, the detector temperature is 45° C., the temperature of the columns is 60° C. and the injection concentration is 5 mg·mL⁻¹. The standards used are supplied by the company Agilent under the name PL EasiVial-PEG/PEO (PL2080-0200).

Five soaps (noted S1 to S5) are prepared by mixing the amount of formulation required to obtain the targeted dosage in the emulsion and water at 45° C. The pH of the soap is then adjusted to 2 with hydrochloric acid (Aldrich at 32% in water). The properties of the five soaps are collated in table 2 below, in which the amounts of components a), b) and c) are expressed as weight percentages relative to the total weight of the soap, and the amount of water added is the quantity sufficient for 100% by weight.

TABLE 2

| Soap | Component a) | Component b) | Lignosulfonate c)* |
|---|---|---|---|
| S1 | CecaBase ® 3860 ® (0.5%) | Dinoramox ® S12 (1%) | Vaniperse CB (1%) |
| S2 | CecaBase ® 3860 (0.5%) | Dinoramox ® S12 (1%) | Arbo ™ BL (1%) |
| S3 | CecaBase ® 3860 (0.5%) | Dinoramox ® S12 (1%) | GSA (1%) |
| S4 | Dinoram ® SLB (0.5%) | Dinoramox ® S12 (1%) | Vaniperse CB (1%) |
| S5 | CecaBase ® 3860 (0.5%) | Inipol ® CX15 at (1%) | Vaniperse CB (1%) |

*Expressed as weight of solids

Slow emulsions according to the standard NF EN 13808 are manufactured with the aid of a laboratory group from the company EmulBitume (http://www.emulbiturne.com) equipped with an Atomix C colloidal mill. The mass content of bitumen is 60%. The bitumen used is a paraffinic bitumen with a penetrability of 160/220, sold by the company Total and originating from the Feyzin refinery (Rhône, France). The temperature of the bitumen during the preparation of the emulsion is 140° C.

The emulsions prepared from soaps S1 to S5 are numbered E1 to E5, respectively.

Another emulsion, emulsion E6, is produced with soap S1: the mass content of bitumen is 55%. The bitumen used is a paraffinic bitumen with a penetrability of 70/100, sold by the company Total. This bitumen is fluxed to 10% before making the emulsion. The fluxing agent used is sold by the company VWR under the reference “Kerdane-light distillate for petroleum product testing”.

### Example 1

The results of characterization of the main properties of these emulsions E1 to E5 are characterized by a sedimentation stability test according to the standard EN12847 and by a cement test (percentage of material retained on a screen) according to the standard EN12848, and are collated in table 3 below:

TABLE 3

| | Recommendations | E1 | E2 | E3 | E4 | E5 |
|---|---|---|---|---|---|---|
| Stability D-S (%) | <5% | <5% | <5% | <5% | <5% | <5% |
| Cement test | <2% | <2% | <2% | <2% | <2% | <2% |

These first tests demonstrate that all emulsions comprising a formulation according to the present invention are stable and pass the cement test.

### Example 2: Coating Quality Tests

Ten (10) different surfacing mixes are prepared using the five emulsions E1 to E5 produced previously and with two different qualities of aggregates G1 and G2. Aggregate G1 is a Veze basalt (France, Massif Central region), with a particle size distribution: 45% by weight of 0/4 mm, 20% by weight of 4/6 mm and 35% by weight of 6/10 mm). Aggregate G2 is a Sirolaise limestone (France, South-East region), with a particle size distribution: 40% by weight of 0/4 mm, 20% by weight of 4/6 mm and 40% by weight of 6/14 mm).

The surfacing mixes are prepared from the emulsions described above by mixing with the aggregates G1 and G2, according to the techniques well known to those skilled in the art. These surfacing mixes are then evaluated according to various criteria:

The coating quality is performed and evaluated according to the standard NF P98-257-1. For the grading after 2 hours (t0+2), in order to better represent the terrain phenomena and notably the resistance to ravelling on reworking, the surfacing mix is first stored in a pile, and then, at the time of observation, worked with a metal spatula for 30 seconds before spreading it and performing the grading.

The mechanical strength R and the water resistance r/R are evaluated according to the standard NF P98-251-4. The results are presented in Table 4 below:

TABLE 4

| | Recommendations | E1 | E2 | E3 | E4 | E5 |
|---|---|---|---|---|---|---|
| Binder content | >3.8 | 4.2 | 4.2 | 4.2 | 4.2 | 4.2 |
| of the | | | | | | |
| surfacing mix | | | | | | |
| (weight %) | | | | | | |
| Coating quality | — | 100/90 | 100/100 | 100/100 | 100/90 | 100/100 |
| G1 - (t0/t0 + | | | | | | |
| 2) % | | | | | | |
| Coating quality | — | 100/100 | 100/90 | 100/90 | 100/100 | 100/100 |
| G2 - (t0/t0 + | | | | | | |
| 2) % | | | | | | |
| R (MPa) - G1 | >3.5 | 4.0 | — | 4.7 | 4.1 | 4.3 |
| R (MPa) - G2 | >3.5 | 7.3 | — | 7.5 | 7.2 | 6.5 |
| r/R - G1 | >0.55 | 0.63 | — | 0.65 | 0.69 | 0.65 |
| r/R - G2 | >0.55 | 0.64 | — | 0.65 | 0.66 | 0.69 |

The surfacing mixes prepared using the formulations according to the invention all have a good coating quality (percentage of coverage t0) and good resistance to ravelling on reworking (percentage of coverage t0+2). Similarly, all of the formulations meet the specifications as recommended by the standards in terms of mechanical strength (R) and water resistance (r/R).

### Example 3: Impregnation Test

The impregnation test is performed according to the standard NF EN 12849:2009-08 with emulsion E6 described above, at ambient temperature. Emulsion E6 fully meets the criteria of the abovementioned standard insofar as it totally impregnates the sand in a time of less than 20 minutes, and the surface of the sand after impregnation is clearly recognized.

1. A formulation comprising:
a) at least one nitrogenous cationic surfactant bearing at least one optionally quaternized fatty chain, and including from 0 to 5, limits inclusive, alkoxylated units;
b) at least one alkoxylated cationic compatibilizer, including from 5 to 25, limits exclusive, alkoxylated units; and
c) at least one lignosulfonate.

2. The formulation as claimed in claim 1, wherein said at least one nitrogenous surfactant a) is chosen from amine surfactants of fatty amine or alkylamidoamine or alkylimidazoline type and mixtures thereof, including up to 5 alkoxylated units and comprising at least one linear or branched, saturated or unsaturated hydrocarbon-based chain, including from 8 to 30 carbon atoms, limits inclusive.

3. The formulation as claimed in claim 1, wherein said at least one nitrogenous surfactant a) is chosen from:
i) an optionally alkoxylated fatty monoamine of formula (I) below: 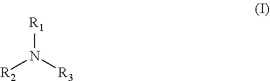
wherein:
R₁ represents a saturated or unsaturated, linear or branched hydrocarbon-based chain, including from 8 to 30 carbon atoms, limits inclusive,
R₂ and R₃, which may be identical or different, are chosen from a hydrogen atom, a linear or branched, saturated or unsaturated alkyl radical, including from 1 to 4 carbon atoms, and an alkoxylated unit (CH₂CHR₄O)ₕH, wherein R₄ represents a hydrogen atom or a methyl or ethyl radical, h being a number ranging from 1 to 5, limits inclusive, where when h is greater than 1, the groups R₄ may be identical or different;
ii) an optionally alkoxylated fatty polyamine of formula (II) below: 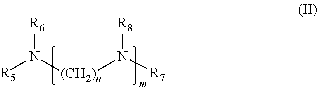
wherein:
R₅ represents a saturated or unsaturated, linear or branched hydrocarbon-based chain, including from 8 to 30 carbon atoms, limits inclusive,
R₆, R₇ and R₈, which may be identical or different, are chosen from a hydrogen atom, a linear or branched, saturated or unsaturated alkyl radical, including 1 to 4 carbon atoms, and an alkoxylated unit (CH₂CHR₉O)ᵢH, wherein R₉ represents a hydrogen atom or a methyl or ethyl radical, i being a number ranging from 1 to 5, wherein when h is greater than 1, the groups R₉ may be identical or different;
m denotes a number chosen from 1, 2, 3, 4, 5 and 6 wherein when m is greater than 1, the groups R₈ may be identical or different,
n denotes a number chosen from 1, 2, 3, 4, 5 and 6; and
iii) an optionally alkoxylated fatty amidoamine, of formula (Ma) below or the optionally alkoxylated cyclized equivalent thereof, of formula (IIIb) below: 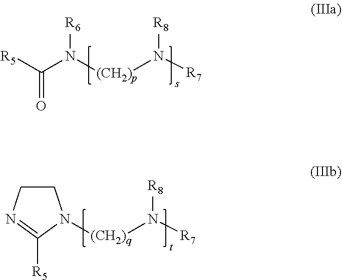
wherein:
the groups R₅, R₆, R₇ and R₈ are as defined,
p and q are chosen from 1, 2, 3, 4, 5 and 6,
s denotes an integer between 1 and 10, limits inclusive,
t denotes an integer between 0 and 9, limits inclusive,
wherein when s and t are strictly greater than 1, the groups R₈ may be identical or different.

4. The formulation as claimed in claim 1, wherein said at least one alkoxylated cationic compatibilizer b) is chosen from fatty-chain amines, fatty-chain alkylamidoamines, fatty-chain alkylimidazolines, quaternized derivatives of said amines, alkylamidoamines and alkylimidazolines, and mixtures thereof, said at least one compatibilizer b) including from 5 to 25, limits exclusive, alkoxylated units and comprises at least one linear or branched, saturated or unsaturated hydrocarbon-based chain, including from 8 to 30 carbon atoms, limits inclusive.

5. The formulation as claimed in claim 1, wherein said at least one alkoxylated cationic compatibilizer b) is chosen from:
i) an alkoxylated fatty monoamine of formula (I′) below: 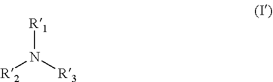
wherein
R′₁ represents a saturated or unsaturated, linear or branched hydrocarbon-based chain, including from 8 to 30 carbon atoms, limits inclusive,
R′₂ and R′₃, which may be identical or different, represent, independently of each other, an alkoxylated unit (CH₂CHR′₄O)ⱼH, wherein R′₄ represents a hydrogen atom or a methyl or ethyl radical, j representing the total number of alkoxylated units per mole of compound of formula (I′) and being a number ranging from 5 to 25, limits exclusive, wherein the groups R¹₄ may be identical or different;
ii) an alkoxylated fatty polyamine of formula (II′) below: 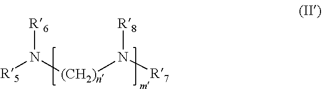
wherein
R′₅ represents a saturated or unsaturated, linear or branched hydrocarbon-based chain, including from 8 to 30 carbon atoms, limits inclusive,
R′₆, R′₇ and R′₈, which may be identical or different, represent an alkoxylated unit —(CH₂CHR′₉O)ⱼH, wherein R′₉ represents a hydrogen atom or a methyl or ethyl radical, j representing the total number of alkoxylated units per mole of compound of formula (II′) and being a number ranging from 5 to 25, limits exclusive, wherein the groups R′₉ may be identical or different;
m′ denotes a number chosen from 1, 2, 3, 4, 5 and 6, wherein when m′ is greater than 1, the groups Ws may be identical or different,
n′ denotes a number chosen from 1, 2, 3, 4, 5 and 6; and
iii) an alkoxylated fatty amidoamine, of formula (III′a) below or the cyclized equivalent thereof of formula (III′b) below: 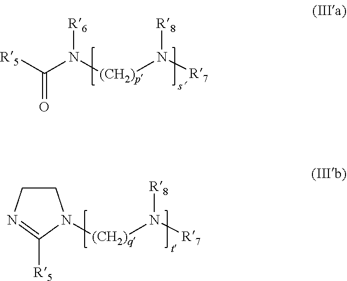
wherein
the groups R′₅, R′₆, R′₇ and R′₈ are as defined previously,
p′ and q′ are chosen from 1, 2, 3, 4, 5 and 6,
s′ denotes an integer between 1 and 10, limits inclusive,
t′ denotes an integer between 0 and 9 limits inclusive,
wherein when s′ and t′ are greater than 1, the groups R′₈ may be identical or different.

6. The formulation as claimed in claim 1, wherein said at least one alkoxylated cationic compatibilizer b) is chosen from:
fatty amines and polyamines based on coconut, tallow or palm, ethoxylated with between 5 and 25 equivalents per mole,
methyl chloride-quaternized derivatives of fatty amines and polyamines based on coconut, tallow or palm, and including in total from 5 to 25 (limits exclusive) ethoxylated units per mole,
ethoxylated derivatives (total ethoxylated units between 5 and 25 per mole, limits exclusive) of mixtures of fatty alkylamidopolyamine and of fatty alkylimidazopolyamines obtained by reaction of fatty acids or of plant or animal oils such as coconut, tallow, palm, pine (or tall oil) fatty acids, octanoic, nonanoic, decanoic, undecanoic, dodecanoic, lauric, myristic, cetylic, stearic, oleic, arachidic or behenic acid with polyethylene polyamines such as diethylenetriamine (DETA), triethylenetetramine (TETA), tetraethylenepentamine (TEPA), aminoethylpiperazine (AEP), pentaethylenehexamine (PEHA), dimethylaminopropylamine (DMAPA) and dimethylaminopropylaminopropylamine (DMAPAPA).

7. The formulation as claimed in claim 1, wherein component a) and/or component b) of the formulation may be present in quaternized form.

8. The formulation as claimed in claim 1, wherein component c) is a lignosulfonate chosen from sodium, calcium, magnesium or ammonium lignosulfonates.

9. The formulation as claimed in claim 1, wherein component c) is a lignosulfonate with a weight-average molar mass (Mw) of between 1 kg·mol⁻¹ and 35 kg·mol⁻¹, limits inclusive.

10. The formulation as claimed in claim 1, wherein the component b)/component c) weight ratio is between 0.1 and 4, limits inclusive, and the component a)/component b) weight ratio is between 0.1 and 2, limits inclusive.

11. The use of a formulation as claimed in claim 1, as a surfactant for the preparation of a bitumen emulsion.

12. The use as claimed in claim 11, wherein the formulation is present in a dose of between 0.1% and 5%, by weight of formulation, limits inclusive, relative to the total weight of the bitumen emulsion.

13. A process for preparing a bitumen emulsion from a formulation as claimed in claim 1, said process comprising:
at least one step of mixing at least one bitumen, at least one said formulation and water,
an optional step of acidification of the medium so as to obtain a pH value of less than 7,
said process being performed at a temperature between ambient temperature and 160° C.

14. A bitumen emulsion substantially obtained according to the process of claim 13.

15. The use of a bitumen emulsion as claimed in claim 14 for preparing surfacing mixes, semi-warm surfacing mixes, cold-laid surfacing mixes, gravel emulsions (structuring or reprofiling gravel emulsions), cold-laid bituminous concretes, dense, semi-dense or open storable surfacing mixes, for making tack coats, for stabilizing grounds and impregnation works, cold-in-place recycling, for preparing coatings, optionally in combination with one or more other additives and/or fillers, for preparing sealing coatings.
